(19) United States
(12) Patent Application Publication
(10) Pub. No.: US 2016/0314702 A1
(43) Pub. Date: Oct. 27, 2016

(54) INDIVIDUALLY CUSTOMIZED ONLINE LEARNING SYSTEM

(71) Applicant: Hyung Yong PARK, Seoul (KR)

(72) Inventor: Hyung Yong PARK, Seoul (KR)

(21) Appl. No.: 15/106,820

(22) PCT Filed: Dec. 22, 2014
(86) PCT No.: PCT/KR2014/012649

§ 371 Date: Jun. 20, 2016

(30) Foreign Application Priority Data
Dec. 24, 2013 (KR) 10-2013-0162614

(51) Int. Cl. G09B 7/077; G06F 17/30; G06Q 50/20

(52) U.S. Cl. CPC G09B 7/077; G06Q 50/20; G06F 17/30864; G06F 17/30554; G06F 17/30525

(57) ABSTRACT

Disclosed is an individually-customized online learning system which, when respective learners make online connections using terminals belonging to the learners, automatically discloses learning problems on the terminals of respective learners, which instructs the learners to solve the learning problems using the terminals, which receives the learner's answers through the terminals and evaluates the students' grades, which additionally provides information regarding time taken to solve each problem, information regarding answers to respective problems, and information regarding solving of respective problems, and which can automatically adjust the difficulty level of the automatically disclosed problems using information regarding time taken to solve each problem and to submit the answer and information regarding erroneous answers to corresponding problems, thereby disclosing problems according to the learning level of learners.

### TECHNICAL FIELD

The present invention relates to an individually-customized online learning system, and more particularly, to an individually-customized online learning system which, when respective learners make online connections using terminals belonging to the learners, automatically shows learning problems on the terminals of respective learners, instructs the learners to solve the learning problems using the terminals, receives the learners' answers through the terminals and evaluates the students' grades, additionally provides information regarding time taken to solve each problem, information regarding answers to respective problems, and information regarding solving of respective problems, and automatically adjusts the difficulty level of the automatically shown problems using the information regarding time taken to solve each problem and submit the answer and information regarding wrong answers to corresponding problems, thereby showing problems according to the learning levels of the learners.

### BACKGROUND ART

So far, generally, examinations are taken at schools by filling answers on an exam paper and then writing the answers down in an answer sheet such as an OMR card.

In typical examination methods using exam papers, examiners have mental stress and also physical pain because the examiners always have to select problems to be set in an examination.

In addition, in the typical examinations taken using s exam paper, an unfair examination such as cheating (that is, sneaking a look at another person's answer sheet) are often discovered because answers are written down on an exam paper or an OMR card. Furthermore, in the typical examinations taken using exam papers, examination problems are classified into hard problems, medium problems, and easy problems to be set. However, difficulty levels of the problems are just classified by the examiners, and thus are significantly different from actual difficulty levels students are feeling because times taken by respective applicants to solve a problem are not known. Accordingly, examiners cannot know about which problems the learners feel were difficult and thus have difficulties in adjusting the difficulty levels of the problems according to academic abilities of the learners.

Of course, for an examination such as a national assessment of educational achievement that adopts an absolute grading system, examiners equally write problems for each difficulty level regardless of the academic abilities of the learners.

On the other hand, for an examination such as a quiz or a mock test that proceeds in order to enhance the academic abilities of the learners, examiners have many difficulties in writing problems for each level according to the levels of the academic abilities of the learners.

Furthermore, for the typical examinations taken using exam papers, examination scores of the learners who took an examination such as a quiz or a mock test are recorded and managed, but it is difficult to secure a learning problem solving time that is objective data about which problems the learners felt were difficult. Accordingly, it is also difficult to provide an individually-customized examination appropriate for the academic abilities of the learners because it is not easy to be aware of the problems which the learners felt were difficult.

As described above, in order to break away from the typical examination taken using the exam paper in the related art, Korean Patent No. 10-2004-0098169, entitled “Apparatus and method for online education using a mock test,” provides a new learning mock test suitable for a writing criterion of an actual test such as a certificate examination, a scholastic ability test, and a national examination by using information on correct answers or wrong answers that is collected while mock tests for past test questions of a certificate examination, a scholastic ability test, and a national examination are conducted online.

In the related art, as described above, the apparatus and method for online education using a mock test may store problem information and wrong-answer information in the form of a database (DB), unlike the typical examination taken using the exam paper, and then enhance the academic ability of the learner by instructing the learner to solve past test questions associated with the wrong-answer information.

The related art stores the problems in the form of a DB and provides an environment in which learners may take an examination online, but is inadequate to provide the same environment as an actual examination. Accordingly, this is too difficult to apply to an actual examination.

Furthermore, the related art cannot adjust the difficulty levels of the problems according to the academic abilities of the learners, like the conventional examination taken using the exam paper, and thus essentially accompanies a problem in which an examiner has to set the difficulty levels of the problems appropriate for the academic abilities of the learners.

### DISCLOSURE

### Technical Problem

The present invention is designed to solve a defect caused by a conventional examination method using exam papers. The present invention provides an individually-customized online learning system that sets problems appropriate to an academic ability of a learner without performing a separate task for adjusting difficulty level of the problem by providing a learner terminal allocated to each learner and allowing an examination to be taken online using an examination server that provides an examination problem in cooperation with the learner terminal to mark the examination and also by recording and managing problem information, a solving time for the problem information, and wrong answer information for each problem, determining which problem the learner feels is difficult, and automatically segmenting and classifying difficulty levels of problems that are set online using the solving time for the problem information and the wrong answer information for each problem.

In addition, the present invention is designed to solve a defect such as cheating in a conventional examination method using exam papers. The present invention provides an individually-customized online learning system providing a learner terminal allocated to each learner, allowing an examination to be taken online using an examination server that provides an examination problem in cooperation with the learner terminal, and allowing examination problems provided to the learner terminal to be set for each learner in a different order of answers or in a different order of problem numbers.

### Technical Solution

An individually-customized online learning system according to the present invention includes an examination server including a problem DB including problem information and example information subordinate to the problem information and a learner DB including learner information that is pre-registered, recorded, and managed, and configured to output the problem information and the example information included in the problem DB when the learner information included in the learner DB is authenticated, the problem information and the example information being subordinate to the authenticated learner information; and a learner terminal interworking with the examination server and configured to connect to the examination server, perform authentication from the examination server by inputting learner information, and receive the problem information and the example information from the examination server when the authentication is successful. The learner terminal outputs the problem information and the example information to a screen, generates selection information when one piece of the example information subordinate to the problem information is selected by an input device, matches the selection information with the problem information, the example information, and the learner information such that the selection information is subordinate to the problem information, the example information, and the learner information, and transmits the selection information matched with the problem information, the example information, and the learner information to the examination server to generate examination record information. The learner terminal connects to the examination server and enables the examination record information to be watched.

When the examination server transmits the problem information and the example information to the learner terminal, the examination server may transmit examination start information informing that an examination is started, measure time after the examination start information is transmitted, and transmit examination end information to the learner terminal when a predetermined time has passed. When the examination start information is received, the learner terminal may output an examination start informing window to a screen to inform a learner that the examination is started. When the examination end information is received, the learner terminal may stop outputting the problem information and the example information to the screen and may transmit the selection information subordinate to the problem information and the example information in a batch such that the selection information is subordinate to the learner information of the examination server.

The problem information may include unique problem ID values and problem number information, the example information subordinate to the problem information may further include example ID values and number information corresponding to the problem information, and a piece of the example information corresponding to an actual answer of the problem information may further include a correct-answer identification value in addition to an example ID value and number information. The learner terminal may be provided in plurality, and each of the plurality of learner terminals may perform authentication with different learner information. When the problem information and the example information are output from the examination server, the problem number information of the problem information and the number information of the example information subordinate to the problem information may be output differently to the plurality of learner terminals.

When the learner selects the problem information, and thus the learner terminal generates the selection information, the selection information may be subordinate to an example ID value of a selected piece of the example information subordinate to the problem ID value of the problem information. When the examination through the learner terminal is ended, the examination server may receive the problem information and the example information output to the learner terminal and the selection information subordinate to the example ID value in addition to the problem information and may store the problem information, the example information, and the selection information such that the problem information, the example information, and the selection information are subordinate to the learner information. The examination server may determine whether the correct-answer identification value and the selection information are included in the example ID value, may determine a correct answer when both of the correct-answer identification value and the selection information are included, and may determine a wrong answer when both of the correct-answer identification value and the selection information are not included.

The learner terminal may receive a plurality of pieces of the problem information and a plurality of pieces of the example information from the examination server, then output only one piece of the problem information to the screen, and then output an examination solving window in which example information subordinate to the one piece of the problem information is output. The learner terminal may output a next-problem selection window for passing to a next examination solving window in the examination solving window. When the next-problem selection window is selected, the learner terminal may output another piece of the problem information and then output an examination solving window in which the example information subordinate to the other piece of the problem information is output.

The learner terminal may receive the plurality of pieces of the problem information and the plurality of pieces of the example information from the examination server and then may output a list window in which numbers of the plurality of pieces of the problem information are determined to a portion of the examination solving window. When any one is selected from among the numbers of the list window, the learner terminal may output problem information subordinate to the selected number to the screen and then may output an examination solving window in which example information subordinate to the output problem information is output.

When the learner terminal generates the selection information, the learner terminal may include an example ID value of a selected piece of the example information subordinate to problem ID values of the problem information, the learner terminal may start measuring a problem solving time when the problem information and the example information are output to the screen and may end measuring the problem solving time and simultaneously store solving time information subordinate to an ID value of the problem information when the next-problem selection window is selected. When the examination through the learner terminal is ended, the examination server may receive and store the problem information and the example information output to the learner terminal, the selection information subordinate to the problem information, and the solving time information subordinate to the ID value of the problem information such that the problem information, the example information, the selection information, and the solving time information are subordinate to the learner information.

The problem information may further include difficulty levels, the learner terminal may transmit a difficulty level range input value for a numerical range input to each of the difficulty levels, and the examination server may transmit only one piece of the problem information corresponding to the difficulty level range input value to the learner terminal.

The learner terminal may include an example ID value of a selected piece of the example information subordinate to a problem ID value of the problem information. When an examination of the learner terminal is ended, the examination server may receive and store the problem information and the example information output to the learner terminal and the selection information subordinate to the problem information such that the problem information, the example information, and the selection information are subordinate to the learner information, the examination server may determine whether a correct-answer identification value is included in the example ID value included in the problem ID value included in the selection information, may determine a correct answer when the correct-answer identification value is included, may determine a wrong answer when the correct-answer identification value is not included, may perform a process of recording answer information in the learner information for each piece of the problem information, may generate priority information in the learner information, beginning with a learner who got the greatest number of correct answers, may calculate a grade range value by dividing the total number of learners who took the examination by the number of difficulty levels of the problem information, may designate a range corresponding to the grade range value as a ranking class in decreasing order of the priority information, and may record the ranking class in the learner information. When there is a correct answer of the problem information for each learner, the examination server may compare a ranking in the ranking class with the difficulty level of the problem information, may decrease the difficulty level of the problem information by a certain value and then record the decreased level when the ranking in the ranking class is higher than the difficulty level of the problem information, and may increase the difficulty level of the problem information by a certain value and then record the increased level when the ranking in the ranking class is lower than the difficulty level of the problem information.

When there is a wrong answer of the problem information for each learner, the examination server may compare the ranking in the ranking class with the difficulty level of the problem information, may increase the difficulty level of the problem information by a certain value and then record the increased level when the ranking in the ranking class is higher than the difficulty level of the problem information, and may decrease the difficulty level of the problem information by a certain value and then record the decreased level when the ranking in the ranking class is lower than the difficulty level of the problem information.

When the learner terminal is authenticated while the problem information whose difficulty level is adjusted is recorded, the examination server may transmit the problem information and the example information to the learner terminal.

### Advantageous Effects

According to the present invention, it is possible to resolve mental stress and physical pain of an examiner, which are caused because the examiner has to select problems to be written for each of conventional examinations taken using an exam paper by breaking away from the typical method that uses an exam paper and taking, recording, and managing an examination online.

Also, according to the present invention, it is possible to prevent an unfair examination such as cheating that often occurs in the conventional method that uses an exam paper by outputting problems and examples in the different orders for each learner terminal.

Also, according to the present invention, a difficulty level is assigned to the problem information. The difficulty level of the problem information may be automatically decreased when learners having a high academic grade hit a correct answer of a high-level problem, and the difficulty level of the problem information may be automatically increased when learners having a high academic grade do not hit a correct answer of a high-level problem. Thus, a difficulty level that is set when an examiner such as a teacher generates and stores the problem information and the example information in an initial problem DB may be different from a difficulty level the learner actually feels. In this case, it is possible to write a problem appropriate to an actual academic ability of each learner and thus enhance the academic ability by changing the set difficulty level to the difficulty level the learner actually feels through the above-described automatic adjustment.

Also, according to the present invention, it is possible to prevent an unfair examination such as cheating that often occurs in the conventional method that uses an exam paper by forming a plurality of pieces of example information corresponding to a correct answer, forming a greater number of pieces of example information corresponding to a wrong answer than a number of number information, selecting and automatically outputting only one piece of the example information corresponding to the correct answer when a problem is output to the learner terminal, and selecting and automatically outputting pieces of the example information corresponding to a wrong answer according to the number of problems that are output.

### DESCRIPTION OF DRAWINGS

FIG. 1 is a block diagram showing elements constituting an individually-customized online learning system according to an embodiment of the present invention.

FIG. 2 is an exemplary diagram showing an example in which problem information and example information are displayed on a screen of a learner terminal shown in FIG. 1.

FIG. 3 is a table summarizing data values included in problem information and example information registered in an examination server shown in FIG. 1 in order to understand the data values of the problem information and the example information.

FIG. 4 is an exemplary diagram showing an example in which a GUI interface having the form of an OMR answer sheet is implemented on a screen of a learner terminal shown in FIG. 2.

FIG. 5 is an exemplary diagram showing an example in which problem information and example information that are different from those shown in FIG. 2 are displayed.

FIG. 6 is a table summarizing data values included in problem information and example information registered in an examination server shown in FIG. 5 in order to understand the data values of the problem information and the example information.

### BEST MODES FOR CARRYING OUT THE INVENTION

These and other objectives and features of the present invention will become more fully apparent from the following description taken in conjunction with the accompanying drawings.

Unless otherwise defined, all terms (including technical and scientific terms) used herein have the same meaning as commonly understood by one of ordinary skill in the art to which this invention belongs. Terms such as terms that are generally used and have been in dictionaries should be construed as having meanings matched with contextual meanings in the art. In this description, unless defined clearly, terms are not ideally or excessively construed as formal meanings.

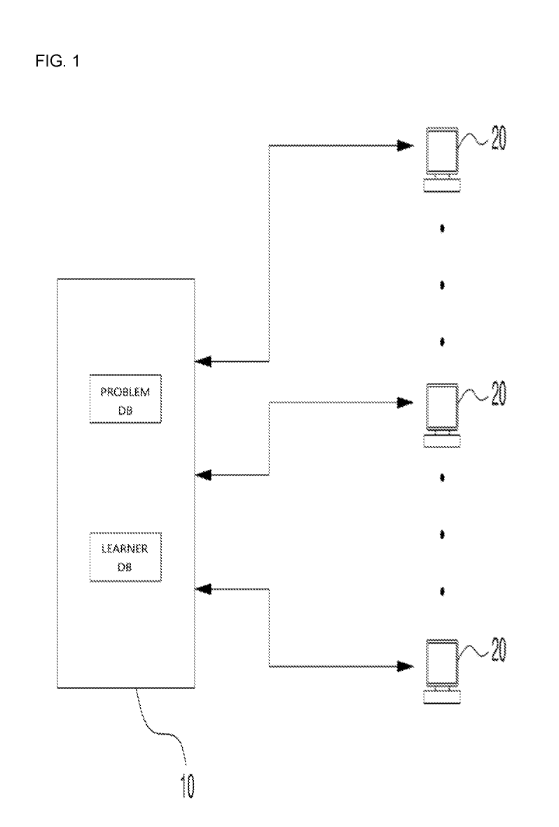

An individually-customized online learning system according to an embodiment of the present invention will be described in detail with reference to FIGS. 1 to 3.

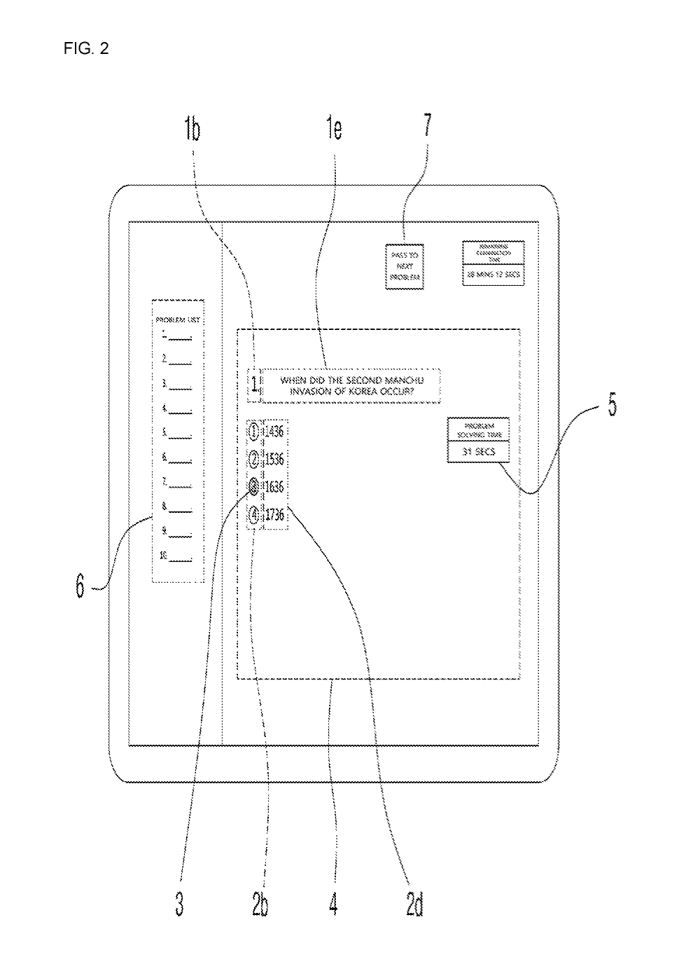

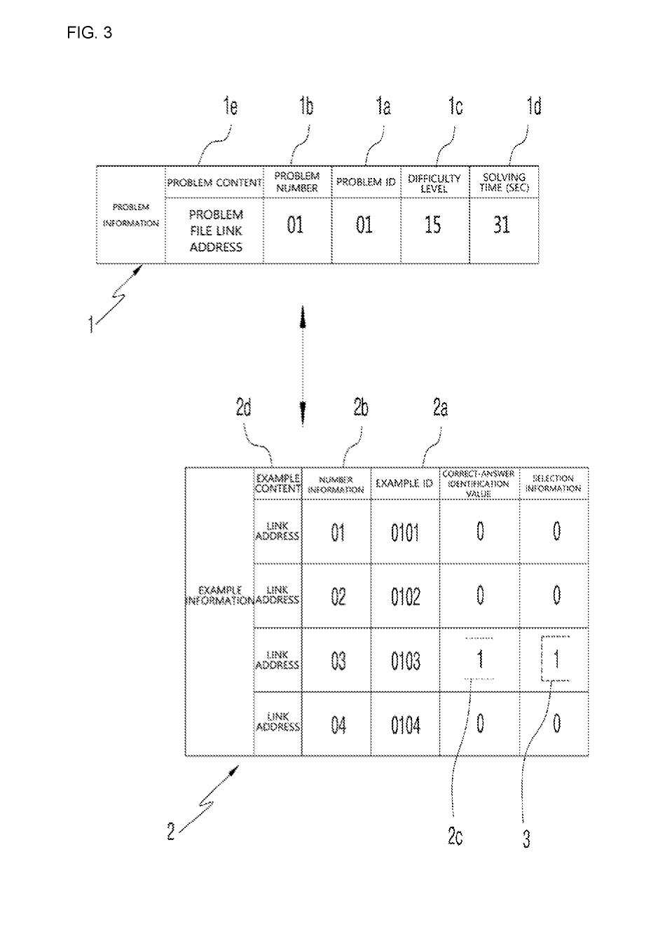

FIG. 1 is a block diagram showing elements constituting an individually-customized online learning system according to an embodiment of the present invention. FIG. 2 is an exemplary diagram showing an example in which problem information and example information are displayed on a screen of a learner terminal shown in FIG. 1. FIG. 3 is a table summarizing data values included in problem information and example information registered in an examination server shown in FIG. 1 in order to understand the data values of the problem information and the example information.

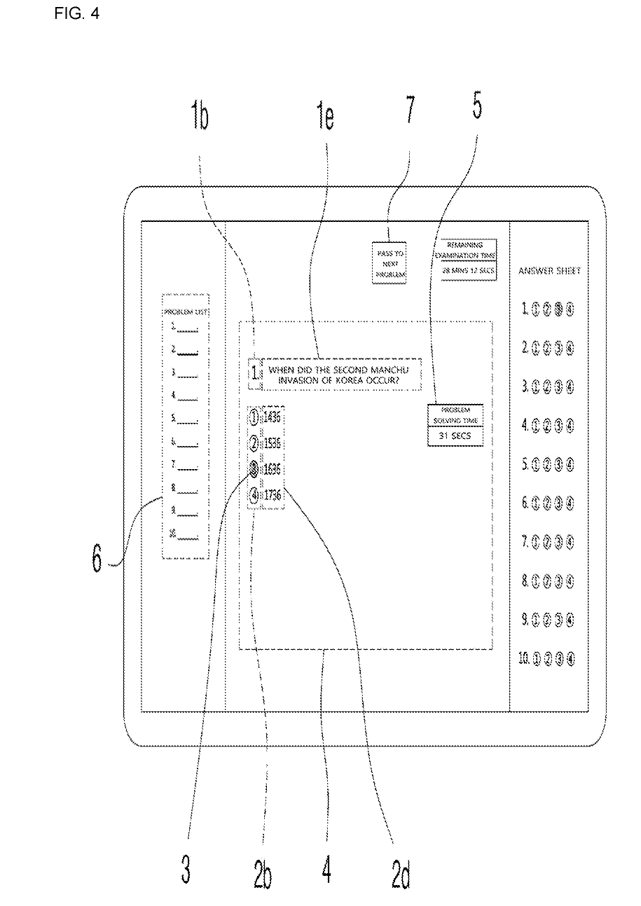

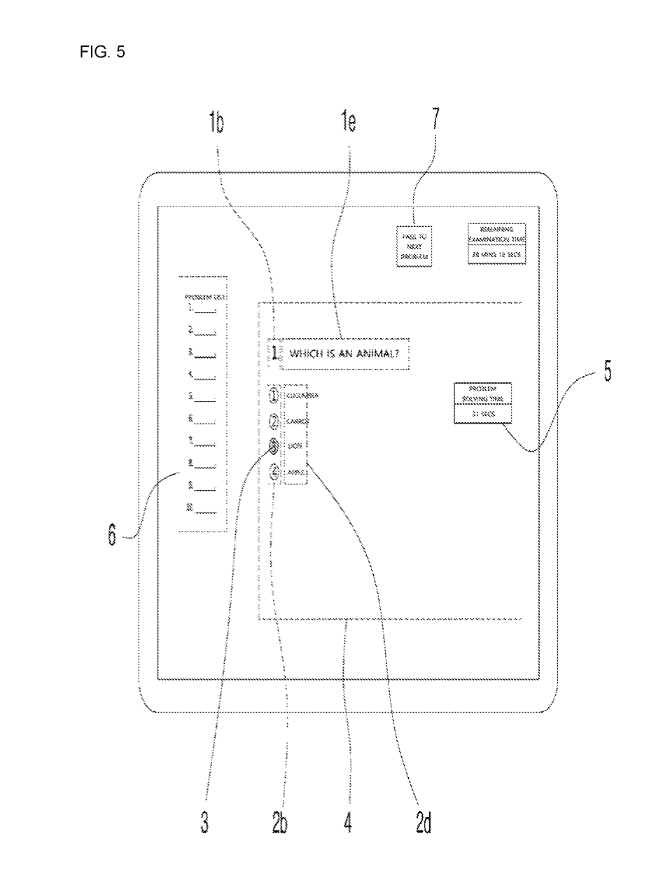

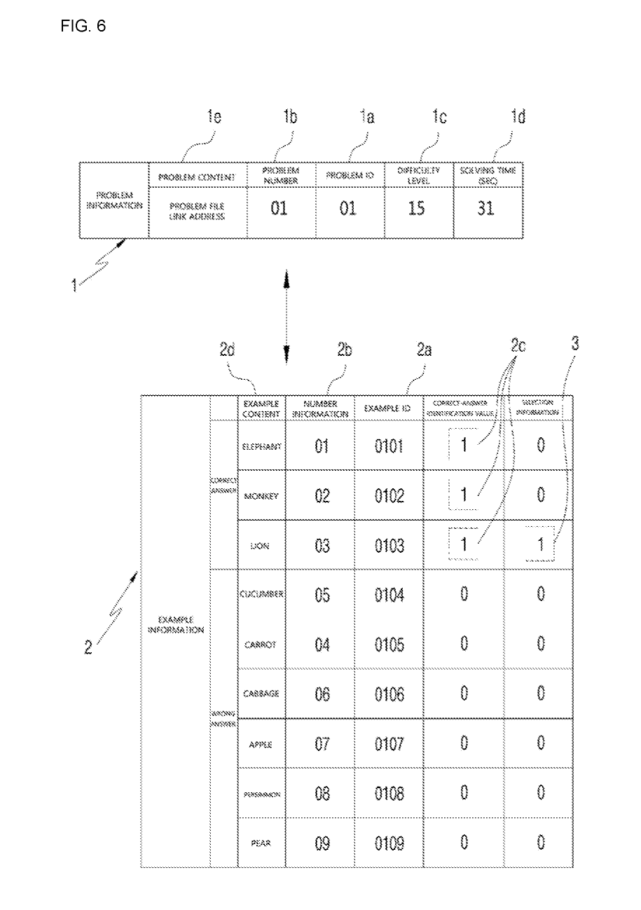

FIG. 4 is an exemplary diagram showing an example in which a GUI interface having the form of an OMR answer sheet is implemented on a screen of a learner terminal shown in FIG. 2. FIG. 5 is an exemplary diagram showing an example in which problem information and example information that are different from those shown in FIG. 2 are displayed. FIG. 6 is a table summarizing data values included in problem information and example information registered in an examination server shown in FIG. 5 in order to understand the data values of the problem information and the example information.

First, elements constituting an individually-customized online learning system according to an embodiment of the present invention will be described below in detail.

As shown in FIG. 1, the individually-customized online learning system according to an embodiment of the present invention includes an examination server 10 and a learner terminal 20.

The examination server 10 is a server that is connected to a wired or wireless communication network and configured to transmit or receive data and then record and manage the transmitted or received data. The examination server 10 includes a learner DB. In the learner DB, learner information regarding respective learners is collected as data. Here, the learner information may include information such as personal data, exam information, ranking information, and server connection authentication information of the respective learners. The learner information is a unique value that allows a learner to connect to the examination server 10 using his/her unique authentication information, take an examination, and record examination information corresponding to the examination in his/her unique account when the learner connects to the examination server 10 through the learner terminal 20 to be described below. Here, in order for learners to acquire unique authentication authority when the learner terminal 20 connects to the examination server 10, the learner information may further include student numbers and fingerprint information of the learners, and the examination server 10 may perform authentication when the included student numbers and the fingerprint information are input from the learner terminal 20.

Also, the examination server 10 further includes a problem DB. The problem DB includes problem information 1 and example information 2 that are to be written in an examination. Here, the problem information 1 is stored in the examination server 10 such that problem content 1e about image data or text data on a question of a problem may be output to the screen of the learner terminal 20. In addition, the example information 2 is subordinate to the problem information 1. The example information 2 is stored in the examination server 10 such that example content 2d about image data or text data is output to the learner terminal 20. In this case, the problem information 1 further includes problem number information 1b and unique ID values of the problem information 1 to be described below, in addition to the content of the question. The example information 2 may be configured to include example ID values 2a and number information 2b, and thus may record and manage the problem information 1 and the example information 2. Technical features of the problem information 1 and the example information 2 will be described in more detail in addition to technical features according to this embodiment.

The learner terminal 20 is configured as a terminal capable of communication such as a personal computer (PC). That is, the learner terminal 20 may be configured to include elements such as a mouse, a keyboard, a main body of a computer, and a monitor. The learner terminal 20 is used by a learner to make connection when the learner desires to take an examination. When the learner enters learner information through an input device, the learner terminal 20 sends the learner information to the examination server 10 to perform authentication. When the authentication is made, the learner terminal 20 receives the problem information 1 and the example information 2 from the examination server 10 and outputs the problem information 1 and the example information 2 to the screen. In this case, when the learner selects specific example information 2 subordinate to the problem information 1 through the input device of the learner terminal 20, the learner terminal 20 generates selection information 3, thus allowing the learner to take an examination online. Here, in order to easily output the problem information 1 and the example information 2 provided by the examination server 10 to the screen, an examination solving program for outputting the problem information 1 and the example information 2 may be separately installed and then used in the learner terminal 20. Here, the examination solving program may include an authentication means for performing authentication between the learner terminal 20 and the examination server 10, a communication means for performing connection between the learner terminal 20 and the examination server 10 to transmit or receive data, and a driving means for technical features according to driving of this embodiment to be described below. Detailed technical contents will be described in more detail in addition to technical features according to the driving of this embodiment.

In order to describe detailed technical features of an individually-customized online learning system including the above-described elements according to an embodiment of the present invention in more detail, a more detailed description will be described in detail, in addition to the driving of the individually-customized online learning system according to an embodiment of the present invention.

As discussed in the background section, the individually-customized online learning system according to an embodiment of the present invention is designed to break away from the conventional method that uses an exam paper. For this, each learner may take an examination through interconnection between the examination server 10 including the problem information 1, the example information 2, and the learner information and the learner terminal 20 used by the learner.

First, in order to take an examination, learners take the examination using the learner terminals 20 while the learners gather together in a class. In this case, before the examination, the learner connects to the learner terminal 20 through his or her own unique student number or fingerprint information.

In this case, the learner terminal 20 connects to the examination server 10 and inputs the learner information to perform authentication from the examination server 10.

Next, the examination server 10 receives the learner information from the learner terminal 20 and determines whether the learner information indicates that each learner has authentication authority through the above-described student information or fingerprint information. When the authentication is made, the number of questions selected by a manager such as a teacher from the problem information 1 in the problem DB recorded in the examination server 10 is output to the learner terminal 20.

In this case, for an examination having the recorded form such as a quiz or a mock test, the problem information 1 and the example information 2 output to the learner terminal 20 may be selected by a manager having authority to manage the examination server 10 and may be selected in a batch upon a learner's request in order for the learner to evaluate his or her ability.

When the problem information 1 and the example information 2 are output to the learner terminal 20, the learner selects one piece of the example information 2 subordinate to the problem information 1 through an input device such as a mouse that is connected with the learner terminal 20 and allows the selection information 3 to be generated. In this case, as shown in drawings, when the selection information 3 is selected by an input device such as a mouse, the learner terminal 20 may variably output a phrase or a question number of the example information 2 to change a color thereof such that the learner may easily recognize the change.

In this case, the selection information 3 generated by the learner terminal 20 is transmitted to the examination server 10 while the selection information 3 is subordinate to and matched with the problem information 1, the example information 2, and the learner information.

In this way, the learner records the selection information 3 for the problem information 1 and example information 2 written in the learner terminal 20 and stores the selection information 3 in the examination server 10 as examination recording information.

Subsequently, after the learner records the selection information 3 in all the problem information 1 written by the examination server 10 through the learner terminal 20, that is, after one subject is completed or a predetermined examination period has passed, the learner connects to the examination server 10 through the learner terminal 20 to read the examination recording information recorded by the learner.

In this case, when the learner connects to the learner terminal 20 to read the examination recording information, the examination server 10 provides solution information for the problem information 1 in addition to the examination recording information.

In this way, the individually-customized online learning system of the present invention may resolve mental stress and physical pain of an examiner, which are caused because the examiner has to select problems to be written for each of conventional examinations taken using an exam paper, by breaking away from the typical method that uses an exam paper and taking, recording, and managing an examination online.

When scholastic performance is classified in a quiz or a mock test, the individually-customized online learning system according to an embodiment of the present invention may allow all learners in a specific grade or in a specific class to take an examination using the examination server 10.

For this, when the learner performs authentication through the learner terminal 20, and the examination server 10 sends the problem information 1 and the example information 2 to the learner terminal 20, the examination server 10 transmits examination start information that informs the learner about the start of the examination and, at the same time, starts to measure time from the moment when the examination start information is transmitted.

In this case, the examination start information may be implemented in the form of an examination start informing window for a phrase that informs about the start through the screen of the learner terminal 20 or may be implemented in the form of a stopwatch that informs about the remaining time of the examination in real time through the screen of the learner terminal 20.

Next, after a predetermined time, the examination server 10 transmits examination end information to the learner terminal 20.

Then, when the examination end information is received, the learner terminal 20 stops outputting the problem information 1 and the example information 2 to the screen and transmits the selection information 3 subordinate to the problem information 1 and the example information 2 in a batch such that the problem information 1, the example information 2, and selection information 3 are subordinate to the learner information of the examination server 10.

Next, the examination server 10 performs a process of comparing the selection information 3 subordinate to the learner information about learners with correct answer information of the problem information 1. The examination server 10 determines whether the selection information 3 selected by each learner is a wrong answer or a correct answer to mark the examination, calculates a score for each learner, and records the calculated score in the learner information of the learner.

Subsequently, the examination server 10 records and stores a ranking for each subject on the basis of scores subordinate to the learner information.

In this case, as described above, the learner connects to the examination server 10 using the learner terminal 20, and then performs a process of verifying solution information of the problem information 1 and, at the same time, confirms his or her grade through the ranking subordinate to the learner information.

The individually-customized online learning system according to an embodiment of the present invention has the following technical features in order to prevent an unfair examination such as cheating that often occurs in the conventional examination that uses an exam paper.

For this, the problem information 1 includes unique problem ID values 1a and problem number information 1b.

The example information 2 subordinate to the problem information 1 further includes example ID values 2a and number information 2b corresponding to the problem information 1. The example information 2 corresponding to an actual answer of the problem information 1 may further include a correct-answer identification value 2c in addition to the example ID value 2a and the number information 2b.

In this case, the learner terminal 20 is provided in plurality. Each of the plurality of learner terminals 20 performs authentication with different learner information, and when the problem information 1 and the example information 2 are output from the examination server 10, the problem number information 1b of the problem information 1 and the number information 2b of the example information 2 subordinate to the problem information 1 are output differently to the plurality of learner terminals 20.

That is, because a problem and examples that are output to the screen of the learner terminal 20 are output in reverse order of the problem number information 1b and the problem information 1 as described above, a student cannot try cheating by watching another learner terminal 20 through his/her learner terminal 20 due to a different order of problems and a different order of examples.

Accordingly, the individually-customized online learning system according to an embodiment of the present invention may output problems and examples in different orders for each learner terminal 20, thus preventing an unfair examination such as cheating that often occurs in the conventional method that uses an exam paper.

In this case, when the learner selects the problem information 1 and thus the learner terminal 20 generates the selection information 3, the selection information 3 is subordinate to the example ID value 2a of a selected piece of the example information 2 subordinate to the problem ID value 1a of the problem information 1.

Next, when the examination through the learner terminal 20 is ended, the examination server 10 receives and stores the problem information 1 and the example information 2 output to the learner terminal 20 and also the selection information 3 subordinate to the example ID value 2a in addition to the problem information 1 such that the problem information 1, the example information 2, and the selection information 3 are subordinate to the learner information.

In this case, as described above, the examination server 10 determines whether the correct-answer identification value 2c and the selection information 3 are included in the example ID value 2a. The examination server 10 determines a correct answer when both of the correct-answer identification value 2c and the selection information 3 are included in the example ID value 2a and determines a wrong answer in other cases. Thus, as described above, the examination server 10 may mark the examination for each learner and calculate an examination score.

Meanwhile, it will be apparent that the present invention may be implemented by selecting and writing example information 2 using the input device of the learner terminal 20 when an answer is written in the learner terminal 20 and also by implementing a GUI interface such as an OMR card in the learner terminal 20 and then writing answers of problems, as shown in FIG. 4.

In addition, as described above, the individually-customized online learning system according to an embodiment of the present invention executes the following driving in order for the learner to concentrate on solving one problem while taking the examination through the learner terminal 20.

In this case, on a condition that a plurality of pieces of the problem information 1 and the example information 2 are received from the examination server 10, when only one piece of the problem information 1 is output to the screen, the learner terminal 20 outputs an examination solving window 4 in which the example information 2 subordinate to the one piece of the problem information 1 is output to one screen.

Here, the learner terminal 20 outputs a next-problem selection window 7 for passing to the next examination solving window 4 to the examination solving window 4. When the learner selects the next-problem selection window 7 using the input device of the learner terminal 20, the next examination solving window 4 is displayed.

When a learner receives a plurality of pieces of the problem information 1 and a plurality of pieces of the example information 2 from the examination server 10, the individually-customized online learning system according to an embodiment of the present invention may allow the learner to concentrate to solving a problem by outputting only one piece of the problem information 1 and pieces of the example information 2 corresponding to the problem information 1. Like a conventional examination method that uses exam papers and a conventional examination method that opens past examination problems in the form of a file online, this prevents the learner's concentration from dropping when the learner sees several problems at the same time.

Furthermore, as described above, the present invention may be implemented in the form in which only one piece of the problem information is output to one screen through the examination solving window 4 and also in the form in which all pieces of the problem information are output to the screen as one exam paper format by applying this. As described above, it will be apparent that respective areas of the examination solving window 4 are set for the problem information 1 and then the problem information 1 may be changed through a drag function of an input device such as a mouse.

Here, the individually-customized online learning system according to an embodiment of the present invention is a means for allowing a learner to select any one problem from among all written problems and solve the problem because the learner sees one piece of the problem information 1 and its example information 2. When a plurality of pieces of the problem information 1 and their example information 2 are received from the examination server 10, the learner terminal 20 may output a list window 6 in which numbers of the plurality of pieces of the problem information 1 are determined to a portion of the examination solving window 4.

In this case, when any one number is selected from among the numbers of the list window 6 through the learner terminal 20, the learner terminal 20 outputs a piece of the problem information subordinate to the selected number to the screen. That is, a piece of the problem information 1 and its example information 2 selected by the learner are output to the learner terminal 20 in the form of the examination solving window 4.

In this way, by allowing a new examination solving window 4 for the problem information 1, which is randomly selected from the list using the convenience of the learner, to be generated while one piece of the problem information 1 and its example information 2 are output to one examination solving window 4 such that the learner does not lose his or her concentration, the individually-customized online learning system according to an embodiment of the present invention may provide an examination environment that may enhance concentration of the learner even online.

In addition, when the learner sees a piece of the problem information 1 through the learner terminal 20 and then solves the problem, the individually-customized online learning system according to an embodiment of the present invention may inform the learner about a time taken to solve the problem and, at the same time, record and manage the time in the examination server 10.

For this, the learner terminal 20 starts to measure a problem solving time 5 when the problem information 1 and the example information 2 are output to the screen.

In this case, when corresponding problem information 1 is selected, the learner terminal outputs the problem solving time 5 to the screen, and the learner may understand a progress degree of a time for which the learner solves the problem by watching the problem solving time 5 that is output to the screen.

In this case, when the learner selects the next-problem selection window 7 through the learner terminal, the measurement of the problem solving time 5 is ended, and at the same time, solving time information 1d subordinate to an ID value of the problem information 1 is stored.

Next, when the learner solves the next problem information 1 through the learner terminal 20, as described above, the problem solving time 5 about the corresponding problem information 1 is measured.

In this way, when the examination is ended after a predetermined time, the examination server 10 receives and stores the problem information 1 and the example information 2 that are output to the learner terminal 20, the selection information 3 subordinate to the problem information 1, and the solving time information 1d subordinate to the ID value of the problem information 1 such that the information is subordinate to the learner information.

Subsequently, when connecting to the examination server 10, managers such as a teacher having manager authority connect to the examination server 10 with their unique authority, and then output information regarding the solving time information 1d needed for the problem information 1 in a batch and analyze the output information.

In this case, when it is determined that only specific problem information 1 needs a lot of time, the manager receives the problem information 1 from the examination server 10 and analyzes a defect of the problem information 1. Thus, it is possible to enhance academic achievement abilities of learners by determining which problem information 1 the learner feels is difficult and providing solution information regarding the same type of problem information 1 to the learners.

In addition, the individually-customized online learning system according to an embodiment of the present invention may allow the learners to solve the problem while selecting a difficulty level of the problem.

For this, the problem information 1 further includes difficulty levels 1c. By using the problem information 1 including the difficulty levels 1c, when the learner connects to the examination server 10 using the learner terminal 20 and then performs authentication, the learner sends a difficulty level range input value for a range of numbers input to the difficulty levels 1c of the problem information 1 through the learner terminal 20 in order to select the difficulty level of the problem information 1. For example, when the difficulty level 1c of the problem information 1 corresponds to a range of 1 to 100, the learner sends a range of 40 to 60, which is a difficulty level range input value corresponding to the difficulty level 1c of the problem information 1 the learner intends to solve through the learner terminal 20.

Then, the examination server 10 selects and extracts pieces of the problem information 1 corresponding to the difficulty level range input value having a range of 40 to 60 and then transmits only the extracted problem information 1 to the learner terminal 20.

Thus, after the learners receive and solve problem information 1 appropriate for their academic abilities online, they can enhance academic achievement by solving the problem while adjusting a difficulty level of the problem information 1 for each step.

In addition, the learner may select the difficulty level of the problem information 1 and solve the problem. Unlike this, after taking an examination that determines a grade ranking, such as a quiz or a recording test, the difficulty level of the problem information 1 may be automatically adjusted on the basis of the academic abilities of the learners.

For this, when the examination through the learner terminal 20 is ended, the examination server 10 receives and stores the problem information 1 and the example information 2 output to the learner terminal 20 and also the selection information 3 subordinate to the problem information 1 such that the problem information 1, the example information 2, and the selection information 3 are subordinate to the learner information. Subsequently, the examination server 10 determines whether the correct-answer identification value 2c is included in the example ID value 2a included in the problem ID value 1a included in the selection information 3, determines a correct answer when the correct-answer identification value 2c is included, and determines a wrong answer when the correct-answer identification value 2c is not included. Thus, the examination server 10 may perform a process of recording answer information in the learner information for each piece of the problem information 1 and then generate ranking information in the learner information in decreasing order of the number of correct answers of the learner. That is, the ranking information is data for determining grade rankings of all learners who have taken an examination.

Next, the examination server 10 calculates a class range value by dividing the total number of learners who have taken the examination by the number of difficulty levels 1c of the problem information 1. A range corresponding to the class range value from the highest place to the lowest place of the ranking information is designated as a ranking class and recorded in the learner information.

For example, when the total number of learners who have taken the examination is 400, and the number of difficulty levels 1c is 100, which range from 1 to 100, the class range value is 4. In this case, the ranking class may be classified into a total number of 40 classes from the top ranking to the bottom ranking. That is, a first grade ranking to a fourth grade ranking are classified as a first class, a fourth grade ranking to an eighth grade ranking are classified as a second class, or the like.

Subsequently, when there is a correct answer of the problem information 1 for each learner, the examination server 10 compares a ranking in the ranking class with a difficulty level 1c of the problem information 1. When the ranking in the ranking class is higher than the difficulty level 1c of the problem information 1, the examination server 10 decreases the difficulty level 1c of the problem information 1 by a certain value and records the decreased difficulty level 1c. When the ranking in the ranking class is lower than the difficulty level 1c of the problem information 1, the examination server 10 increases the difficulty level 1c of the problem information 1 by a certain value and records the increased difficulty level 1c.

For example, when a learner who has a ranking in the ranking class being a tenth class hits a correct answer of a problem with the difficulty level 1c of the problem information 1 being 15, the examination server 10 may decrease the difficulty level 1c of the problem information 1 by a certain value, that is, from 15 to 14 and then may record the decreased difficulty level 1c. When the learner who has a ranking in the ranking class being a twentieth class hits a correct answer of a problem with the difficulty level 1c of the problem information 1 being 15, the examination server 10 may increase the difficulty level 1c of the problem information 1 by a certain value, that is, from 15 to 16 and then may record the increased difficulty level 1c.

Similarly, when there is a wrong answer of the problem information 1 for each learner, the examination server 10 compares a ranking in the ranking class with a difficulty level 1c of the problem information 1. When the ranking in the ranking class is higher than the difficulty level 1c of the problem information 1, the examination server 10 may increase the difficulty level 1c of the problem information 1 by a certain value and then may record the increased difficulty level 1c. When the ranking in the ranking class is lower than the difficulty level 1c of the problem information 1, the examination server 10 may decrease the difficulty level 1c of the problem information 1 by a certain value and then may record the decreased difficulty level 1c.

For example, when a learner who has a ranking in the ranking class being a tenth class selects a wrong answer of a problem with the difficulty level 1c of the problem information 1 being 15, the examination server 10 may increase the difficulty level 1c of the problem information 1 by a certain value, that is, from 15 to 16 and then may record the increased difficulty level 1c. When a learner who has a ranking in the ranking class being a twentieth class selects a wrong answer of a problem with the difficulty level 1c of the problem information 1 being 15, the examination server 10 may decrease the difficulty level 1c of the problem information 1 by a certain value, that is, from 15 to 14 and may record the decreased difficulty level 1c.

While the problem information 1 having a difficulty level adjusted in this way is recorded in the examination server 10, as described above, the problem information 1 may be provided to the learner through the learner terminal 20.

Like this, the difficulty level of the problem information 1 may be automatically decreased when learners having a high academic grade hit a correct answer of a high-level problem. The difficulty level of the problem information 1 may be automatically increased when learners having a high academic grade do not hit a correct answer of a high-level problem. Thus, a difficulty level 1c that is set when an examiner such as a teacher generates and stores the problem information 1 and the example information 2 in an initial problem DB may be different from a difficulty level the learner actually feels. In this case, it is possible to write a problem appropriate to an actual academic ability of each learner and thus enhance the academic ability by changing the set difficulty level 1c to the difficulty level the learner actually feels through the above-described automatic adjustment.

Also, as described above, the individually-customized online learning system according to an embodiment of the present invention may output a number of the number information 2b of the example information 2 differently for each learner terminal 20 to prevent an unfair examination such as cheating. In addition, by forming a plurality of pieces of the example information 2 corresponding to a correct answer and also forming a greater number of pieces of the example information 2 corresponding to a wrong answer than the number of number information 2b, only one piece of the example information 2 corresponding to the correct answer is selected and automatically output when the problem information is output to the learner terminal 20, and pieces of the example information 2 corresponding to a wrong answer are selected and automatically output according to the number of problems that are output.

For example, as shown in FIGS. 5 and 6, when the problem content of the problem information 1 is to “select an animal from the following,” there are a plurality of pieces, such as, a lion, a monkey, and an elephant, of example information 2 including a correct-answer identification value 2c because the example information 2 is a correct answer, and only a lion is selected from among as a lion, a monkey, and an elephant, which are a plurality of pieces of example information 2, and is automatically written upon outputting the example information 2 to the learner terminal 20, only a cucumber, a carrot, and an apple are automatically selected from among a cucumber, a carrot, a cabbage, an apple, a persimmon, and a pear, which are pieces of the example information 2 corresponding to a wrong answer, and then the selected pieces of example information 2 are output. Accordingly, it is possible to prevent an unfair examination such as cheating by output wrong answer information, rather than correct answer information, differently for each learner terminal 20.

Although the present invention has been described with reference to the specific embodiments and drawings together with specific details such as detailed components, the above description is provided only for better understanding of the present invention and it will be apparent to those skilled in the art that various modifications and variations may be made from the above description.

While exemplary embodiments have been disclosed herein, it should be understood that other variations may be possible. Such variations are not to be regarded as a departure from the spirit and scope of exemplary embodiments of the present application, and all such modifications as would be obvious to one skilled in the art are intended to be included within the scope of the following claims.

1. An individually-customized online learning system comprising:
an examination server (10) comprising a problem DB including problem information (1) and example information (2) subordinate to the problem information (1) and a learner DB including learner information that is pre-registered, recorded, and managed, and configured to output the problem information (1) and the example information (2) included in the problem DB when the learner information included in the learner DB is authenticated, the problem information (1) and the example information (2) being subordinate to the authenticated learner information; and
a learner terminal (20) interworking with the examination server (10) and configured to connect to the examination server (10), perform authentication from the examination server (10) by inputting learner information, and receive the problem information (1) and the example information (2) from the examination server (10) when the authentication is successful, wherein,
the learner terminal (20) outputs the problem information (1) and the example information (2) to a screen, generates selection information (3) when one piece of the example information (2) subordinate to the problem information (1) is selected by an input device, matches the selection information (3) with the problem information (1), the example information (2), and the learner information such that the selection information (3) is subordinate to the problem information (1), the example information (2), and the learner information, and transmits the selection information (3) matched with the problem information (1), the example information (2), and the learner information to the examination server (10) to generate examination record information, and
the learner terminal (20) connects to the examination server (10) and enables the examination record information to be watched.

2. The individually-customized online learning system of claim 1, wherein, when the examination server (10) transmits the problem information (1) and the example information (2) to the learner terminal (20), the examination server (10) transmits examination start information informing that an examination is started, measures time after the examination start information is transmitted, and transmits examination end information to the learner terminal (20),
when the examination start information is received, the learner terminal (20) outputs an examination start informing window to the screen to inform a learner that the examination is started, and
when the examination end information is received, the learner terminal (20) stops outputting the problem information (1) and the example information (2) to the screen and transmits the selection information (3) subordinate to the problem information (1) and the example information (2) in a batch such that the selection information (3) is subordinate to the learner information of the examination server (10).

3. The individually-customized online learning system of claim 1, wherein,
the problem information (1) includes unique problem ID values (1a) and problem number information (1b),
the example information (2) subordinate to the problem information (1) further includes example ID values (2a) and number information (2b) corresponding to the problem information (1),
a piece of the example information (2) corresponding to an actual answer of the problem information (1) further includes a correct-answer identification value (2c) in addition to an example ID value (2a) and number information (2b),
the learner terminal (20) is provided in plurality, and each of the plurality of learner terminals (20) performs authentication with different learner information, and when the problem information (1) and the example information (2) are output from the examination server (10), the problem number information (1b) of the problem information (1) and the number information (2b) of the example information (2) subordinate to the problem information (1) are output differently to the plurality of learner terminals (20).

4. The individually-customized online learning system of claim 3, wherein, when the learner selects the problem information (1), and thus the learner terminal (20) generates the selection information (3), the selection information (3) is subordinate to an example ID value (2a) of a selected piece of the example information (2) subordinate to the problem ID value (1a) of the problem information (1),
when the examination through the learner terminal (20) is ended, the examination server (10) receives the problem information (1) and the example information (2) output to the learner terminal (20) and the selection information (3) subordinate to the example ID value (2a) in addition to the problem information (1) and stores the problem information (1), the example information (2), and the selection information (3) such that the problem information (1), the example information (2), and the selection information (3) are subordinate to the learner information, and
the examination server (10) determines whether the correct-answer identification value (2c) and the selection information (3) are included in the example ID value (2a), determines a correct answer when both of the correct-answer identification value (2c) and the selection information (3) are included, and determines a wrong answer when both of the correct-answer identification value (2c) and the selection information (3) are not included.

5. The individually-customized online learning system of claim 1, wherein, the learner terminal (20) receives a plurality of pieces of the problem information (1) and a plurality of pieces of the example information (2) from the examination server (10), then outputs only one piece of the problem information (1) to the screen, and then outputs an examination solving window 4 in which example information (2) subordinate to the one piece of the problem information (1) is output,
the learner terminal (20) outputs a next-problem selection window (7) for passing to a next examination solving window (4) in the examination solving window (4), and
when the next-problem selection window (7) is selected, the learner terminal (20) outputs another piece of the problem information (1) and then outputs an examination solving window (4) in which example information (2) subordinate to the other piece of the problem information (1) is output.

6. The individually-customized online learning system of claim 5, wherein, the learner terminal 20 receives the plurality of pieces of the problem information (1) and the plurality of pieces of the example information (2) from the examination server (10) and then outputs a list window (6) in which numbers of the plurality of pieces of the problem information (1) are determined to a portion of the examination solving window (4), and
when any one is selected from among the numbers of the list window (6), the learner terminal (20) outputs problem information (1) subordinate to the selected number to the screen and then outputs an examination solving window (4) in which example information (2) subordinate to the output problem information (1) is output.

7. The individually-customized online learning system of claim 5, wherein, when the learner terminal (20) generates the selection information (3), the learner terminal (20) includes an example ID value (2a) of a selected piece of the example information (2) subordinate to problem ID values (1a) of the problem information (1),
the learner terminal (20) starts measuring a problem solving time (5) when the problem information (1) and the example information (2) are output to the screen and ends measuring the problem solving time (5) and simultaneously stores solving time information (1d) subordinate to an ID value of the problem information (1) when the next-problem selection window (7) is selected, and
when the examination through the learner terminal 20 is ended, the examination server (10) receives and stores the problem information (1) and the example information (2) output to the learner terminal (20), the selection information (3) subordinate to the problem information (1), and the solving time information (1d) subordinate to the ID value of the problem information (1) such that the problem information (1), the example information (2), the selection information (3), and the solving time information (1d) are subordinate to the learner information.

8. The individually-customized online learning system of claim 1, wherein, the problem information (1) further includes difficulty levels (1c), the learner terminal (20) transmits a difficulty level range input value for a numerical range input to each of the difficulty levels (1c), and the examination server (10) transmits only one piece of the problem information (1) corresponding to the difficulty level range input value to the learner terminal (20).

9. The individually-customized online learning system of claim 8, wherein, the learner terminal (20) includes an example ID value (2a) of a selected piece of the example information (2) subordinate to a problem ID value (1a) of the problem information (1),
when an examination of the learner terminal (20) is ended, the examination server (10) receives and stores the problem information (1) and the example information (2) output to the learner terminal (20) and the selection information (3) subordinate to the problem information (1) such that the problem information (1), the example information (2), and the selection information (3) are subordinate to the learner information,
the examination server (10) determines whether a correct-answer identification value (2c) is included in the example ID value (2a) included in the problem ID value (1a) included in the selection information (3), determines a correct answer when the correct-answer identification value (2c) is included, determines a wrong answer when the correct-answer identification value (2c) is not included, performs a process of recording answer information in the learner information for each piece of the problem information (1), and then generates priority information in the learner information, beginning with a learner who got the greatest number of correct answers,
the examination server (10) calculates a grade range value by dividing the total number of learners who took the examination by the number of difficulty levels (1c) of the problem information (1), designates a range corresponding to the grade range value as a ranking class in decreasing order of the priority information, and records the ranking class in the learner information,
when there is a correct answer of the problem information (1) for each learner, the examination server (10) compares a ranking in the ranking class with the difficulty level (1c) of the problem information (1), decreases the difficulty level (1c) of the problem information (1) by a certain value and records the decreased level when the ranking in the ranking class is higher than the difficulty level (1c) of the problem information (1), and increases the difficulty level (1c) of the problem information (1) by a certain value and records the increased level when the ranking in the ranking class is lower than the difficulty level (1c) of the problem information (1),
when there is a wrong answer of the problem information (1) for each learner, the examination server (10) compares the ranking in the ranking class with the difficulty level (1c) of the problem information (1), increases the difficulty level (1c) of the problem information (1) by a certain value and records the increased level when the ranking in the ranking class is higher than the difficulty level (1c) of the problem information (1), and decreases the difficulty level (1c) of the problem information (1) by a certain value and records the decreased level when the ranking in the ranking class is lower than the difficulty level (1c) of the problem information (1), and
when the learner terminal (20) is authenticated while the problem information (1) whose difficulty level (1c) is adjusted is recorded, the examination server (10) transmits the problem information (1) and the example information (2) to the learner terminal (20).

10. The individually-customized online learning system of claim 1, wherein the examination server (10) forms a plurality of pieces of the example information (2) corresponding to a correct answer, forms a greater number of pieces of the example information (2) corresponding to a wrong answer than a number of number information (2b), selects and automatically outputs only one piece of the example information (2) corresponding to the correct answer when the problem information is output from the examination server (10) to the learner terminal (20), and selects and automatically outputs pieces of the example information (2) corresponding to a wrong answer according to the number of problems that are output.
